(19) United States
(12) Patent Application Publication
(10) Pub. No.: US 2003/0079386 A1
(43) Pub. Date: May 1, 2003

(54) Picture matte and graphic image display device

(76) Inventor: Wynne Noble, Brooklyn, NY (US)

Correspondence Address: Frank J. DeRosa, Brown Raysman Millstein Felder & Steiner LLP, 900 Third Avenue, New York, NY, 10022, US

(21) Appl. No.: 10/032,831

(22) Filed: Oct. 25, 2001

(51) Int. Cl. G09F 19/14; A47G 1/06

(52) U.S. Cl. 40/453; 40/768

(57) ABSTRACT

A picture matte for framing one or more pictures that also presents two or more composite graphic images or sets of images for viewing with the picture or pictures. The matte may framed or unframed. In an unframed embodiment, the matte serves as a picture frame or other display device. The invention thereby provides an entertainment or enjoyment value, or commercial value (e.g., advertising, marketing, promotional) in addition to the value(s) presented by the picture or pictures. The two or more graphic images or sets of images in a same field of view as a picture, or in an overlapping field of view with that of the picture. A matte comprises at least two interleaved series or sets of sections that are arranged in a wave-like manner such that each series presents a composite image or a set of images, in addition to the matte presenting at least one picture. The matte may have an opening therein, and at least one picture may be mounted to the matte so as to be exposed in the opening for viewing with the image or images presented by the matte, or the picture may be simply positioned adjacent the matte overlaying a portion thereof without an opening. A matte may be provided for one or more sides of viewing, and mattes may be 2-dimensional or 3-dimensional, and may form picture display objects such as pencil holders, drinking cups and notebook covers.

### BACKGROUND OF THE INVENTION

The invention generally relates to mattes for framing pictures and picture frames and other picture display devices.

### SUMMARY OF THE INVENTION

The invention provides a picture matte for framing one or more pictures that also presents two or more composite graphic images or sets of images for viewing with the picture or pictures. “Image” or “images” are used herein in a broad sense, and encompass images of persons, places, things, characters, figures, graphic designs and abstracts, text, messages, etc., or parts thereof. The matte may be framed or unframed. For example, in an unframed embodiment, the matte serves as a picture frame. Thus, the matte may be part of, or form, a picture frame or other picture display device.

The invention thereby provides an entertainment or enjoyment value, or commercial value (e.g., advertising, marketing, promotional) in addition to the value(s) presented by the picture or pictures. For example, where the picture or pictures are those of a child, the graphic images can be those of licensed characters, such as those available from The Walt Disney Company and Warner Brothers, for example, or text or a message related to the picture or the holder of the matte. The images may also have a personal or other relationship with picture(s), for example, a composite image of a relative such as a grand parent, or a message to a grand parent, etc. This arrangement can personalize the picture frame or matte for the holder thereof beyond simple display of a picture, or can provide advertising, promotion and marketing via a picture, the images and both. Devices incorporating the invention may therefore be provided for many purposes, including personalization, enjoyment, entertainment, marketing, advertising, promotional and/or novelty purposes.

The invention provides the two or more graphic images or sets of images in a same field of view as a picture, or in an overlapping field of view with that of the picture. A matte comprises at least two interleaved series or sets of sections that are arranged in a wave-like manner such that each series presents a composite image or a set of images, in addition to the matte presenting at least one picture. The matte may have an opening therein, and at least one picture may be mounted to the matte so as to be exposed in the opening for viewing with the image or images presented by the matte.

Also, the picture may be simply positioned adjacent the matte overlaying a portion thereof so as to be exposed for viewing with the image or images presented by exposed parts of the matte. In that embodiment, an opening in the matte would not be needed.

The sections of each series of interleaved sections generally face in a common direction so that images or parts of images displayed by the sections of a same series are viewable together, and the sections of different series face in different directions. “Direction” as used in a broad sense and encompasses linear directions as well as directions along a curve, and clockwise and counter-clockwise directions. This configuration allows an observer to view a picture from a first direction together with a first image or set of images displayed by the matte, and to view the picture from a second direction together with a second image or set of images displayed by the matte. Again using the example of a child's picture, the sections of one series of sections may display a composite image of Mickey Mouse, while the sections of another series of sections may display a composite image of Donald Duck. The matte may also be personalized by providing the sections with composite images of grand parents or other relatives, etc., or other images of the child, etc.

The sections of the series may be pre-printed with an image or part thereof, or they may be constructed so as to be suitable for receiving an image or part thereof that can be affixed to or printed on the sections in any suitable manner. The invention provides kits which allow artists, hobbyists and consumers to apply images to wave-like mattes, and/or to attach pictures to wave-like mattes and/or to assemble wave-like mattes into picture frames.

The matte may or may not be surrounded by a frame, and may or may not be covered by a transparent glass or plastic plate. Also, picture frames of various configurations may incorporate an inventive matte. An opening for a picture, if one is used, can have any suitable shape, such as rectangular, circular, triangular, etc., and the matte part and/or any frame may have any suitable shape. Similarly, a picture displayed by the matte part may have any suitable shape. The sections can have any suitable size, depending, for example, on the size of the picture and/or the size or type of image(s) that the sections display.

A matte may be provided for one or more sides of viewing. For one-sided viewing, a matte presents at least one picture and at least two images or sets of images for viewing from a same side of the matte. In that embodiment, the matte is generally two-dimensional when not considering the wave-like configuration of the matte, similar to the manner in which a picture frame may be considered 2-dimensional. For two-sided viewing, a matte may be 2-dimensional, as discussed above, and present at least one picture and at least two images or sets of images from opposite sides of the matte. In this embodiment, pictures may be positioned against the matte without openings, or openings may be provided that do not extend completely through the matte.

Mattes may also be 3-dimensional. For example, a matte or matte sections may be arranged to define, in cross section, an open or closed figure. An open figure may be formed, for example, by two 2-dimensional matte sections, as described above, connected at an angle so as to be self-standing. A closed figure may be, for example, a geometric figure such as polygon, or a tube or other curved figure. In the case of a polygon, each side may be defined by a 2-dimensional matte section that presents at least one picture and at least two images or sets of images from one or two sides thereof. In the case of tubular or other curved figure, at least one picture, curved to follow the contour of the matte, is positioned on one or two sides of the matte. 3-dimensional mattes may be constructed as display device containers, or as display device novelty items, for example, pencil holders, drinking cups, paper weights, etc. In the case of drinking cups and other novelty items, the matte is sandwiched and sealed within spaced walls.

2-dimensional mattes and picture frames may also be configured to form picture frame or other display device novelty objects such as notebook covers, etc.

The wave-like series of sections may be exposed, and thereby provide an undulating surface, or closed by a sheet-like member, or sandwiched between sheet-like members or walls to present a smooth surface. The 3-dimensional figures by be closed on one or more sides, i.e., open on one but less than all sides. A display device pencil holder or drinking cup, for example is open at one end of tubular item. When the sections are closed or sandwiched by sheet-like members, such members are transparent or translucent.

### BRIEF DESCRIPTION OF THE DRAWINGS

The foregoing and other aspects of the invention will become more apparent from the following description of illustrative embodiments thereof and the accompanying drawings which illustrate the invention by way of example. In the drawings:

FIG. 1A is a front view of a matte for a picture according to the invention;

FIG. 1B is a rear view of the matte depicted in FIG. 1;

FIG. 1C is a front perspective view of the matte depicted in FIG. 1 taken from a first direction in which a first image or set of images can be coherently viewed;

FIG. 1D is a front perspective view of the matte depicted in FIG. 1, similar to that depicted ion FIG. 1C, but taken from a second direction, generally opposite to the first direction, in which a second image or set of images can be coherently viewed;

FIG. 1E is a front view of a matte similar to that of FIG. 1, except that an opening is not provided for a picture which is positioned adjacent the matte;

FIG. 2A is a top view of picture frame according to the invention, including a matte, similar to the one depicted in FIG. 1 but having elongate extensions connected thereto for supporting the matte on a surface;

FIG. 2B is a front view of the picture frame depicted in FIG. 2A;

FIG. 2C is a rear view of the picture frame depicted in FIG. 2A;

FIG. 3A is an exploded perspective view of a picture frame according to the invention which includes a matte similar or the same as the matte depicted in FIG. 1;

FIG. 3B is front perspective view of the picture frame depicted in FIG. 3A;

FIG. 4A is an exploded perspective view of a picture frame including the matte depicted in FIG. 1 according to another embodiment of the invention;

FIGS. 4B and 4C are front and rear perspective views, respectively, of the picture frame depicted in FIG. 4A;

FIG. 5 is a front perspective view of a picture frame including a matte similar or the same as the matte depicted in FIG. 1 according to still another embodiment of the invention;

FIGS. 6A, 6B, 6C and 6D are schematic diagrams showing different shapes of a matte according to the invention.

FIG. 7 is a perspective view of a display device including a tubular matte according the invention;

FIG. 8 is a perspective view of a display device including a four-sided matte according to the invention; and

FIGS. 9A and 9B are perspective views of two embodiments of a notebook having a matte for displaying a picture the same as or similar to the matte depicted in FIG. 1.

### DETAILED DESCRIPTION OF THE PREFERRED EMBODIMENTS

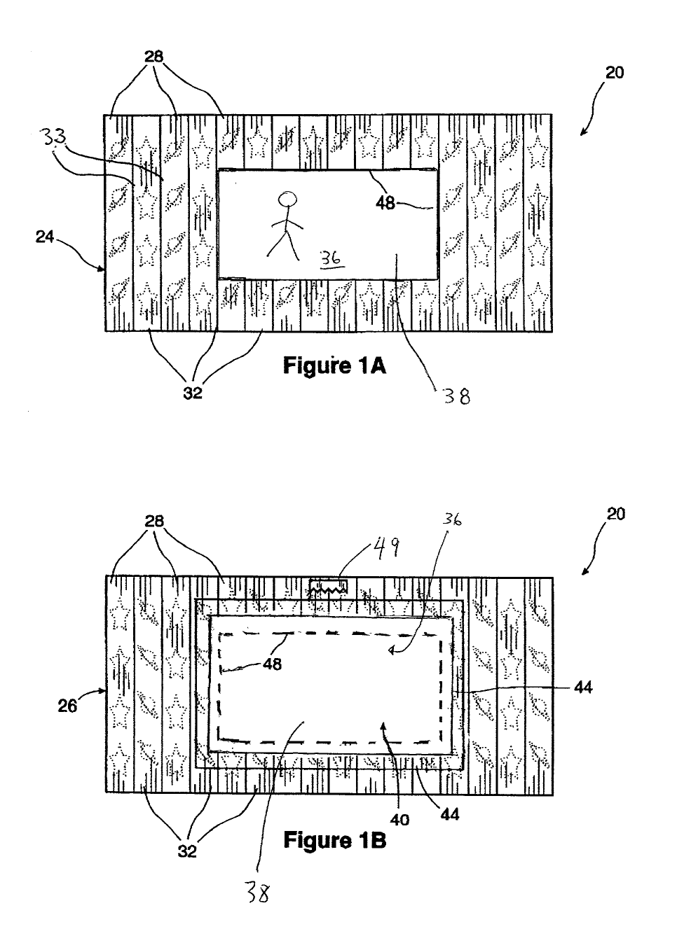

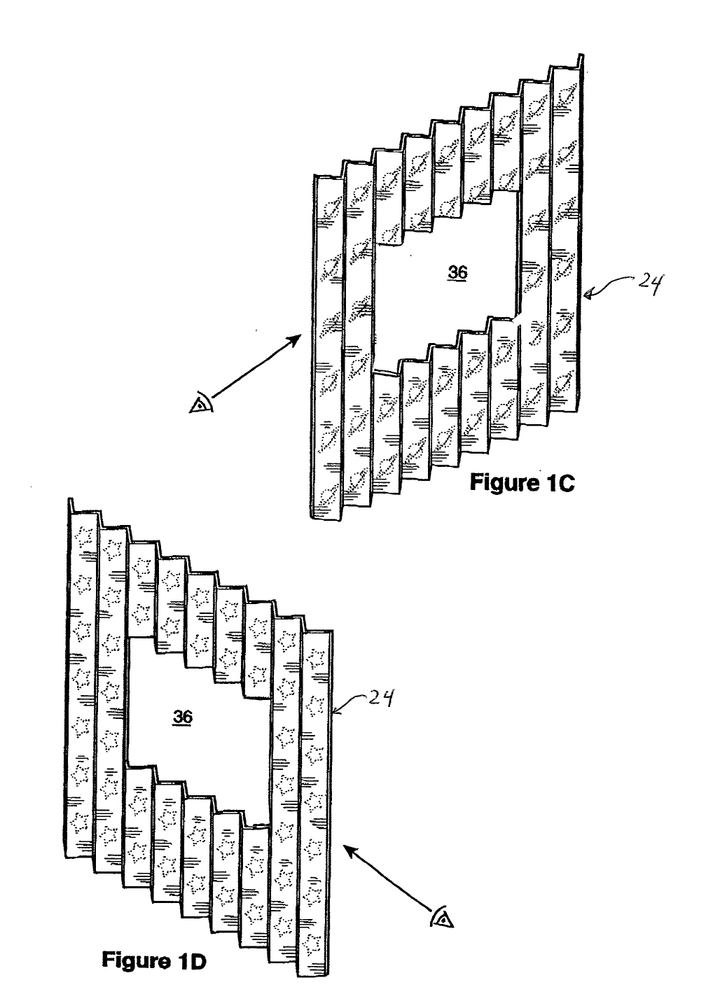

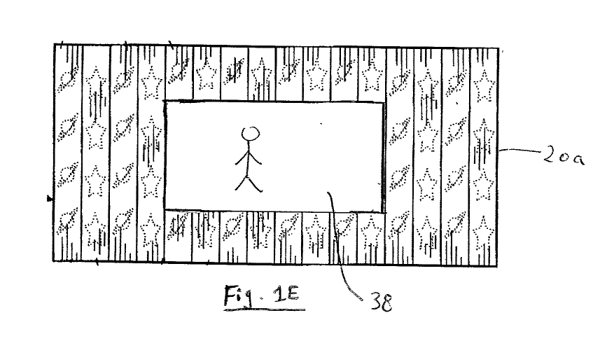

The matte 20 depicted in FIGS. 1A and 1B has a wavelike configuration 24 and comprises two interleaved series of sections 28 and 32 suitable for displaying a composite image or a series of images. The matte 20 may be constructed of any suitable material, such as cardboard or plastic, for example. The sections are shown to be flat, but may have some other configuration that is also suitable for displaying an image or part of an image, e.g., curved or segmented, etc. The sections 28 of one series face in one direction and the sections 32 of the other series face in another direction, here the opposite direction.

Referring to FIG. 1A, the sections 28 of one series and the sections 32 of the other series are alternatively interspersed with each other so that adjacent first and second series sections 28 and 32 have common edges 33. In the preferred embodiments, the common edges 33 are substantially parallel to each other. The phrase “substantially parallel” as used herein, should be interpreted to mean parallel to the degree necessary so that composite image components can be viewed as a composite image from a suitable direction. In another embodiment (not shown), adjacent wave-like sections 28 and 32 do not have common edges but have distinct separated edges. Such edges, however, are preferably also substantially parallel to each other.

The first series of display sections 28 is preferably imprinted with or otherwise carries graphics that form a first composite image, or distinct images that preferably have some relationship to each other or to a picture 38 mounted to the matte. The image or images presented by sections 28 can be coherently viewed from a first angle or direction of observation, as illustrated in FIG. 1C, while the image or images presented by sections 32 can be coherently viewed from a second angle or direction of observation, as illustrated in FIG. 1D.

As illustrated in FIG. 1A, the sections 28 are viewable from a first direction in which the sections 32 are not. The sections 28, 32 of each series of sections carry images, as shown in FIG. 1A that are preferably related, or a composite image (not shown) of a cartoon character, for example. Different symbols are used in FIG. 1A to portray the different images.

The first and second composite images are preferably pre-printed or pre-applied to the sections 28, 32 so as to provide a decorative background against which a picture 38 (e.g., a photograph) selected by the purchaser of the frame can be displayed. For example, the first and second images can be popular cartoon characters, which will provide a suitable backdrop for displaying the picture of a child. The matte 20 can thus be a suitable article for character merchandising.

The matte 24 includes an opening 36 for displaying the picture 38, and means are provided for securing the picture to or against the matte 20 so that the picture may be viewed though the opening 32. The securing means comprises any suitable structure for holding the picture 38 against the matte 20. For example, adhesive or tape, or corner tabs or slits such as are typically used in photo albums or to hold photos taken at amusement parks, as well as other means may be used. In the embodiment depicted in FIGS. 1A-1D, a strip such as a contiguous plastic film 40 is disposed on the rear side 26 of the matte 24. The film 40 provides a series of flaps 44 surrounding the opening 36 to form a sheath or pocket in which the picture 38 may be mounted. The contiguous film 40 may be replaced by one or more discrete strips, if desired. In alternative embodiments, if the matte 20 is sufficiently thick and the picture 38 is sufficiently rigid, the picture 38 and opening 36 can be sized so as to provide a friction-fit of the picture 38 within the internal periphery 48 of the opening 36. Similarly, the matte 24 can be formed with slots or slits in the periphery 48 of the opening 36 into which the picture 38 may be placed. Other structure for the securing a picture against a matte are discussed below in connection with other embodiments of the invention.

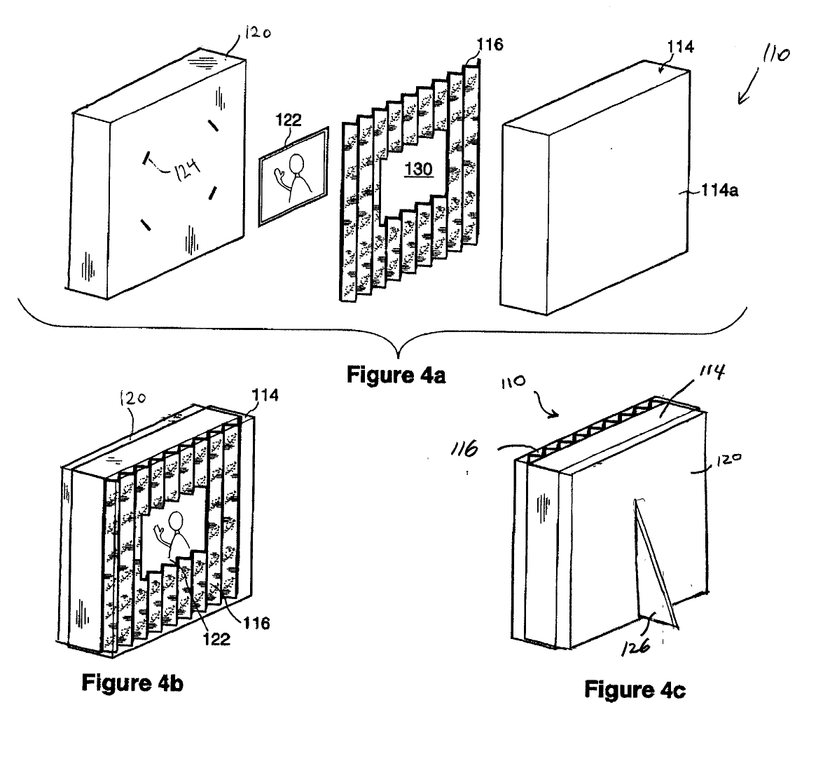

The matte 20 may serve as a picture frame (display device) when provided with some means for supporting it on a wall or a horizontal surface. For example, a hook 49, or a flap similar to flap 126 shown in FIG. 4C, may be attached to the rear of the matte 20.

In another embodiment, a matte 20a is provided that is similar to the matte 20 except that it does not have an opening 36. A picture 38 may be simply positioned adjacent the matte 20a overlaying a portion thereof so as to be exposed for viewing with the image or set of images presented by exposed parts of the matte. The picture 38 can be secured to the matte 20a in any suitable way as, for example, described herein.

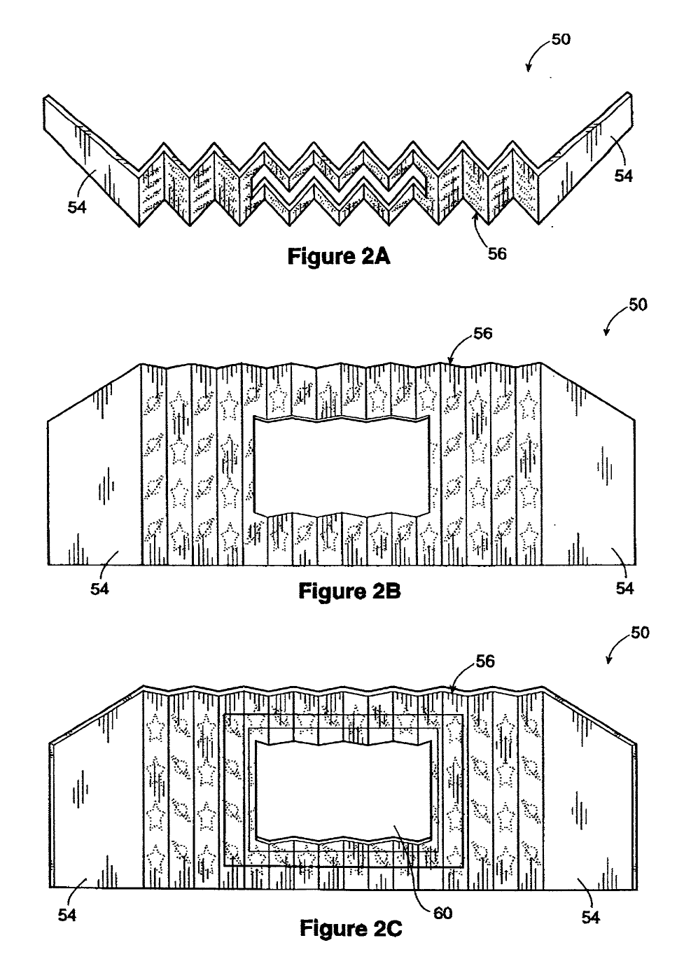

FIGS. 2A, 2B and 2C depict a picture frame (display device) 50 that includes a matte 56 similar to the one depicted in FIGS. 1A-1D. The matte 56 includes, or has connected thereto, elongated or distal or end sections 54 extending therefrom at an angle sufficient to provide support for the matte 56 on a horizontal support surface. The picture frame 50 is thereby self-standing. A picture (not shown) can be held against the matte 56 exposed in the opening 60 as described above.

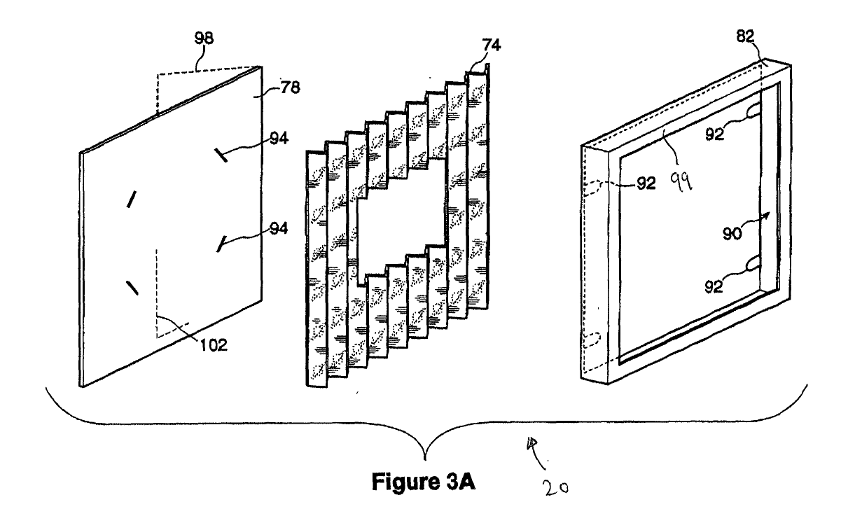

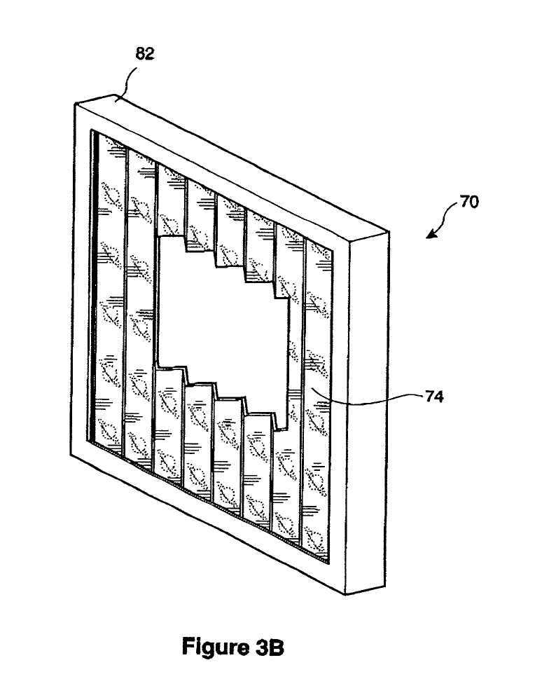

FIGS. 3A and 3B depict another embodiment of a picture frame (display device) 70. In this embodiment, the picture frame 70 includes a frame member 82, that can be conventional (e.g., made of wood, metal or plastic), a matte 74 that can be the same as the matte 20 depicted in FIG. 1, and a conventional backing 78 (e.g., of cardboard). If desired, the backing 78 may be omitted, and other means may be used to hold a picture in the frame member 82, e.g., spring clips and structures typically used to mount a picture in a frame. A hook or flap may be attached to the back of the matte, or a hook may be attached to the back of the frame. The frame member 82, matte 74 and backing 78 may be provided as a kit for assembly by a consumer.

The frame member 82 defines an internal channel 90 for ensconcing the matte 74 and backing 78. Alternatively, a series of rotatable stops or bendable tabs or clips 92 may be provided on the rear of the frame to hold the backing 78 in the frame member 82. The backing 78 may also include slots 94 for mounting a picture thereto (not shown). Additionally or alternatively, a film 98, preferably translucent, (shown in stippled lines) may be provided for mounting the picture the backing 78. The backing 78 preferably also includes a fin-shaped perforation 102 which, when unfolded or extended, will serve as a flap to support the frame 70 on a horizontal surface.

When mounted in the frame member 82, the matte 74 abuts the backing 78, as shown in FIG. 3B. Thus, the backing 78 and frame member 82 collectively provide a means for securing a picture against the matte 74 so that the picture may be viewed though the opening in the matte. In the alternative, the frame member 82 may be omitted and the matte 74 directly secured to the backing 78 by fasteners such as staples or adhesives, thereby providing another variant of the securing means.

The frame member 82 may be a peripheral member that encloses the matte 74 which can be viewed through an opening forming by the peripheral member. That opening may be closed by a transparent sheet of glass or plastic (not shown), as is conventional for picture frames, with the sheet being held in the frame member 82 adjacent the matte 74 in a conventional manner. For example, the sheet may be held between the front peripheral lip 99 of the frame member 82 by the matte 74 and the backing 78, which are held in the frame member 82 as discussed above. In another embodiment, frame element (not shown) may include a transparent front similar to frame member 114 depicted in FIG. 4A.

FIG. 4A depicts another embodiment of a picture frame (display device) 110 according to the invention. In this embodiment, the picture frame 110 includes a matte 116, similar or the same as matte 20, a frame member 114 having a transparent front 114a, a matte 116 that is similar to or the same as matte 20 depicted in FIG. 1, and 3-dimensional backing 120. A picture 122 may be mounted to the backing 120 via slots 124 aligned with the perimeter of an opening 130 in the matte 116. A plastic film (such as film 60 shown in FIG. 2C) or fasteners such as staples or adhesives can be also used to mount the picture 122 to the backing 120.

The backing 120 is box-like and sized to snuggly fit within the frame member 114 so as to hold the matte 116 therein, as shown in FIG. 4B. The rear 120B of the backing 120 preferably includes a fin-shaped perforation 126 which, when extended, forms a flap that enables the picture frame 110 to be self-standing on a horizontal surface, as shown in FIG. 4C. The backing 120 can be held in the frame member 114 by a friction fit, or by tabs or the like projecting (such as tabs 92 depicted in FIG. 3A) from the rear periphery of the frame member 114.

The frame member 114 be similar or the same as frame member 82 depicted in FIG. 3A, except having more depth to accommodate the backing 120, and a transparent sheet, as discussed in connection with FIGS. 3A and 3B, may or may not be provided. In that embodiment, the backing 78 would hold the matte 74 in the frame member as described in connection with FIGS. 3A and 3B.

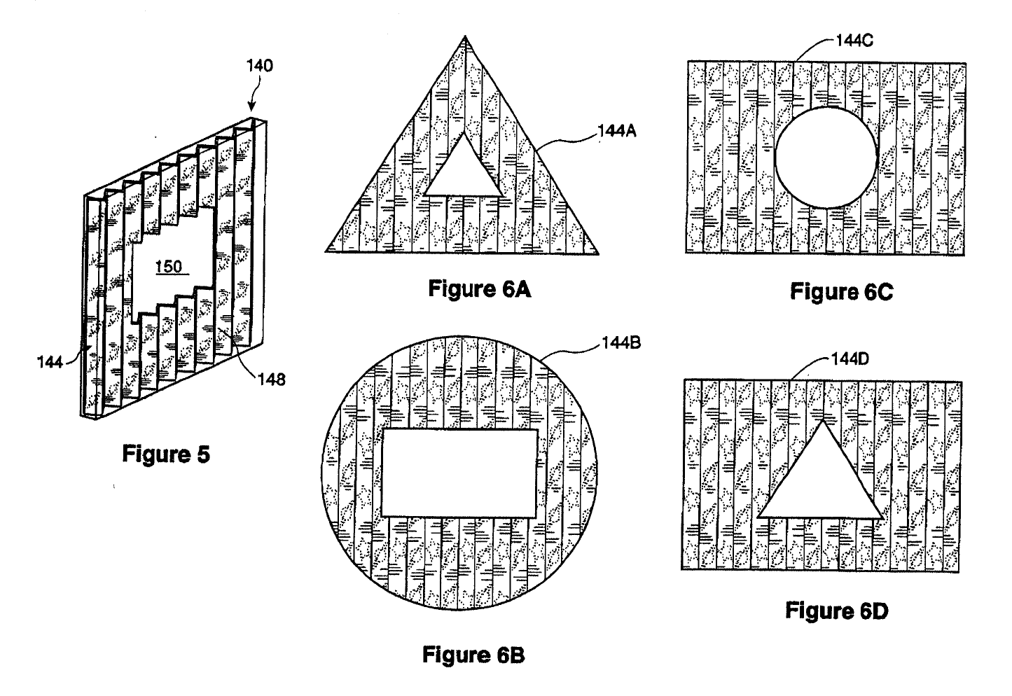

The picture frame (display device) 140 depicted in FIG. 5 includes a matte 148 similar to or the same as matte 20 depicted in FIG. 1 and a transparent frame member 144 forming an enclosure closed on at least one side and having at least one side open to allow the matte 148 to be inserted into the frame member 144. Preferably, the frame member 144 is open on only one side. Also, the frame member 144 need only have a transparent front, rather than being entirely transparent. A backing may be provided between the matte 144 and the rear of the frame member 148. The frame member 144 has sufficient depth to make the picture frame 140 self-standing on a horizontal surface. Alternatively, a hook or other structure can be provided on the rear of the frame member 144 for hanging the picture frame 140 from a wall. A picture can be held against the matte 140 as described above.

The picture frames depicted in FIGS. 1-5 may be provided in kit form for assembly by consumers. The picture frames depicted in FIGS. 1 and 2 need only have a picture secured thereto (or the one or more graphic images), while the picture frames depicted in FIGS. 3-5 would additionally require assembly by a consumer.

The mattes and picture frames depicted in FIGS. 1-5 have been described in connection with viewing from a single side thereof. However, a matte and/or picture frame may be configured for viewing from more than one side. For example, the matte 20a depicted in FIG. 1E and the picture frame 140 depicted in FIG. 5, with a modification to include the matte 20a, may be provided for viewing from opposite sides thereof. The mattes depicted ion FIGS. 1-5 may be considered as being generally 2-dimensional when not considering the wave-like configuration of the matte, similar to the manner in which a picture frame may be considered 2-dimensional. Such 2-dimensional mattes may be configured for two-sided viewing as follows. At least one picture may be held against each side of the matte as described above in connection with FIG. 1E, and at least two images or sets of images are presented by each side as discussed above for one side. A two-sided matte similar to the one depicted in FIG. 1E may be suspended in an open area for two-sided viewing. A two-sided picture frame similar to the one depicted in FIG. 5 may be supported on a horizontal surface where it can be viewed form opposite sides.

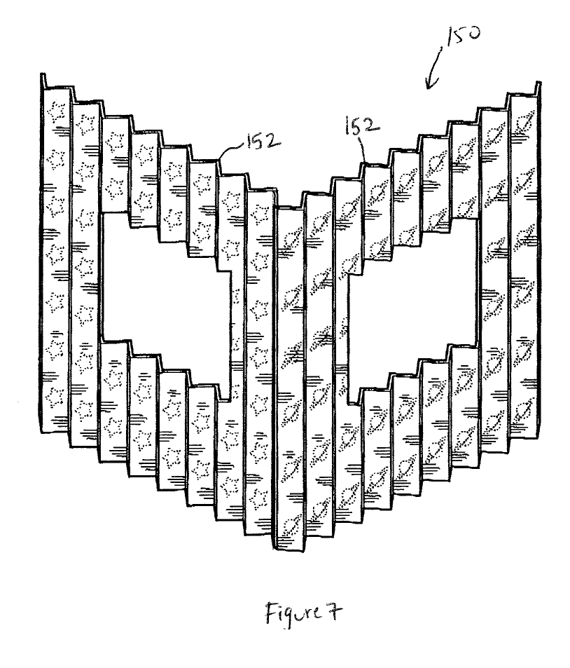

Referring to FIGS. 6A-6D, mattes may be provided in various shapes having openings of various shapes, or may display pictures of various shapes. Mattes may have many shapes other than does depicted in FIGS. 6A-6D, which are exemplary.

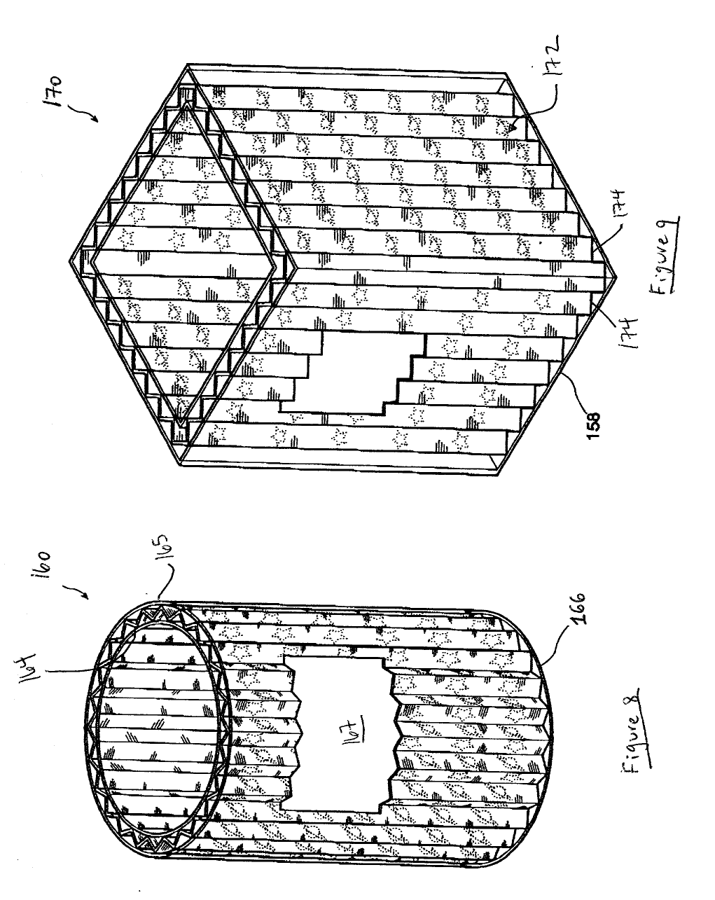

As discussed above, mattes may form part of or be 3-dimensional picture frames and other display devices. FIGS. 7-9 depict 3-dimensional configurations. Referring to FIG. 7, a picture frame 150 may comprise two mattes 152 similar or the same as matte 20 depicted in FIG. 1 joined at a sufficient angle to make the picture frame self-standing. With a wider angle, the two mattes 152 can each be configured for two sided viewing, as described above.

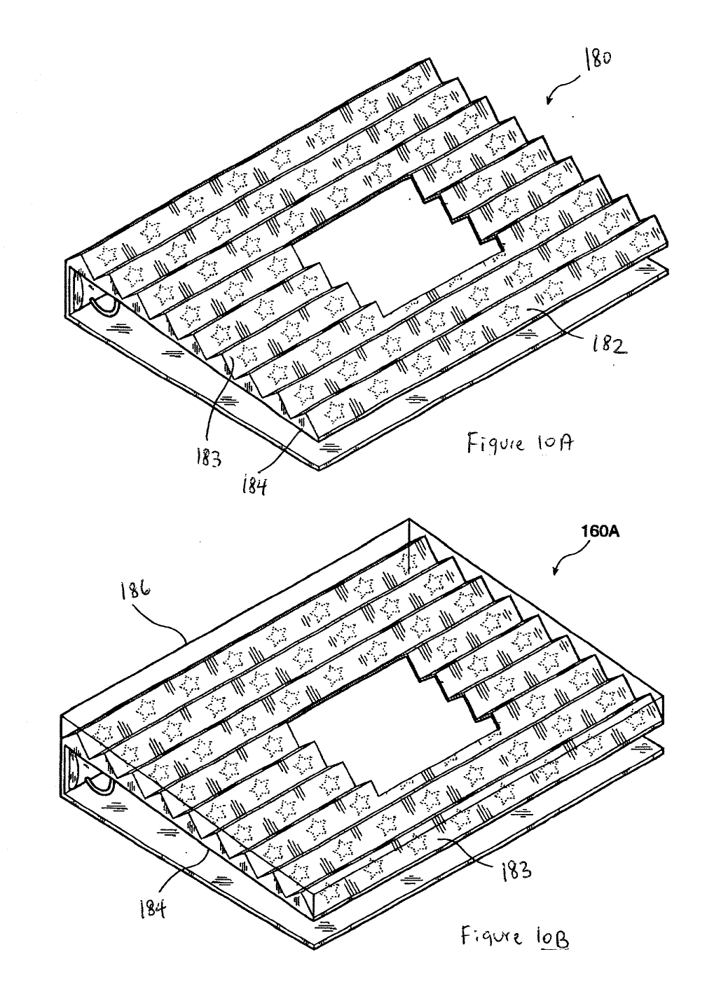

3-dimensional configurations can be open, as depicted in FIG. 7, or closed as depicted in FIGS. 8 and 9. Referring to FIG. 8, a display device 160 is configured as a pencil holder or drinking cup, and includes a tubular matte 162 sandwiched between inner and outer tubular sheets 164, 165 that are sealed in conventional manner at the tops and bottoms thereof. The display device 160 may be constructed similar to the manner that an insulated cup is constructed. One or more pictures may be adhered to the outer tubular sheet 165, or the outer tubular sheet may have an opening 167 therein into which a picture can be inserted and held, e.g., adhered against the inner tubular sheet 164 or flexed against the periphery of the opening. The outer tubular sheet 165 is transparent. However, the matte 162 may be configured for two-sided viewing and the inner tubular sheet 164 may also be transparent.

A four sided display device 170, depicted in FIG. 9, comprises a four section matte 172 and a four double sided walls 174. Each matte section 172 may be similar to or the same as matte 20 depicted in FIG. 1 joined to from a polygon, or the matte sections can be unjoined and held in position by the walls 174. The walls 174 include inner and outer sheets, which can be joined and sealed conventionally. One or more pictures can be held by the picture display device 170 as generally discussed in connection with picture frame 160. The matte sections of matte 162 can be configured for one or two sided viewing as discussed for display device 160.

As discussed above, mattes and picture frames or other display devices can be configured for various applications. FIG. 10A depicts a picture frame 180 attached to or forming the cover of a notebook 182. The picture frame 180 includes a matte 183 similar to the matte 20 depicted in FIG. 1A. The matte 183 may be secured to the cover 184 in any suitable manner. In the embodiment depicted in FIG. 10A, the matte 183 is not covered or enclosed. FIG. 10B depicts an embodiment on which the matte 183 is covered by a transparent enclosure 186 attached to the notebook cover 184. FIGS. 10A and 10B depict embodiments in which a matte or picture frame is secured to only one cover. However, mattes or picture framed may be secured to both covers, as well as to the spine of the notebook. Pictures may be secured to the picture frames and mattes as discussed above.

Kits may be provided as described above. In addition, images may be provided that can be affixed to mattes. Strips with images imprinted thereon and an adhesive backing may be provided as separate items or as part of a kit.

For best visual effects, the sections in each series are preferably flat, of equal size and arranged parallel to each other, with the sections of one series being orientated transversely (preferably an angle in the range of 30 to 60 degrees) to the sections of the other series.

The foregoing descriptions of specific embodiments of the present invention have been presented for purposes of illustration and description. They are not intended to be exhaustive or to limit the invention to the precise forms disclosed, and obviously many modifications and variations are possible in light of the disclosure herein. Those skilled in the art will appreciate that many modifications and variations may be made to the embodiments described herein without departing from the spirit or scope of the invention. The applicant intends that the claims cover all such modifications and variations, and equivalents thereof, permitted by the prior art.

1. A matte for a picture display device, comprising:
at least two series of interleaved sections arranged in a wave-like manner so that sections of each series are viewable by an observer from at least one direction and sections of respective series are viewable from at least one respective direction different from a direction from which sections of another series are viewable;
graphics on a plurality of sections of each set, the graphics defining a composite image or a plurality of related images that are viewable from the respective direction; and
at least one opening in the matte positioned so as to be viewable by an observer from a first direction together with the image or images defined by a first series of sections and in a second direction together with the image or images defined by a second series of sections.

2. A picture display device, comprising:
a matte having at least two series of interleaved sections arranged in a wave-like manner so that sections of each series are viewable by an observer from at least one direction and sections of respective series are viewable from at least one respective direction different from a direction from which sections of another series are viewable;
graphics on a plurality of sections of each set, the graphics defining a composite image or a plurality of related images that are viewable from the respective direction; and
at least one picture associated with the matte so as to be viewable by an observer from a first direction together with the image or images defined by a first series of sections and in a second direction together with the image or images defined by a second series of sections.

3. The matte of claim 1 wherein the matte has opposed first and second sides, each side having the at least two series of sections, the graphics, and at least one of the sides having the opening.

4. The picture display device of claim 2 wherein the matte has opposed first and second sides, each side having the at least two series of sections, the graphics, and at least one of the sides having a picture associated therewith so as to be viewable by an observer from a first direction together with the image or images defined by the first series of sections and in a second direction together with the image or images defined by the second series of sections.

5. The picture display device of claim 2 wherein the matte has an opening therein, a picture being associated with the matte so as to be observable through the opening from the first and second directions.

6. The picture display device of claim 2 comprising means for supporting the matte in a generally vertical orientation.

7. A picture display device comprising the matte of claim 1 and means for supporting the matte in a generally vertical orientation.

8. A picture display device comprising the matte of claim 1, a frame member surrounding at least the periphery of the matte and means for supporting the frame member and the matte with the matte in a generally vertical orientation.

9. A picture display notebook comprising a notebook having at least one cover and the matte of claim 1 secured to the at least one cover.

10. A 3-dimensional display device comprising:
first and second matte sections, each having:
at least two series of interleaved sections arranged in a wave-like manner so that each section of a respective series is viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction; and
at least one opening in at least one of the matte sections positioned so as to be viewable by an observer from a first direction together with the image or images defined by a first series of sections and in a second direction together with the image or images defined by a second series of sections;
the picture display device including means for supporting the first and second matte sections in a self-standing manner in an adjacent relationship so that each is substantially exposed for viewing.

11. The picture display device of claim 10 comprising a plurality of matte sections arranged to form a closed object.

12. The picture display device of claim 10 comprising at least one picture associated with the opening as to be viewable by an observer from a first direction together with the image or images defined by a first series of sections and in a second direction together with the image or images defined by a second series of sections.

13. The picture display device of claim 11 wherein the supporting means comprises structure closing the bottom of the closed object.

14. A 3-dimensional display device comprising:
first and second matte sections, each having:
at least two series of interleaved sections arranged in a wave-like manner so that each section of a respective series is viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction;
the display device including:
at least one picture associated with at least one of the matte sections so as to be viewable by an observer from a first direction together with the image or images defined by a first series of sections and in a second direction together with the image or images defined by a second series of sections; and
means for supporting the first and second matte sections in a self-standing manner in an adjacent relationship so that each is substantially exposed for viewing.

15. A 3-dimensional picture display device comprising:
a matte having at least two series of interleaved sections arranged in a wave-like manner so that sections of each series are viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction, the matte having a tubular shape; and
at least one opening in the matte positioned so as to be viewable by an observer from a first direction together with the image or images defined by a first series of sections and in a second direction together with the image or images defined by a second series of sections;
means for supporting the matte in a self-standing manner.

16. The picture display device of claim 15 wherein the supporting means comprises structure closing the bottom of the tubular matte.

17. A 3-dimensional picture display device comprising:
a matte having at least two series of interleaved sections arranged in a wave-like manner so that sections of each series are viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction, the matte having a tubular shape; and
at least one picture associated with the matte so as to be viewable by an observer from a first direction together with the image or images defined by a first series of sections and in a second direction together with the image or images defined by a second series of sections; and
means for supporting the matte in a self-standing manner.

18. A picture display notebook comprising a notebook having at least one cover and a matte secured to the at least one cover, the matte comprising:
at least two series of interleaved sections arranged in a wave-like manner so that sections of each series are viewable by an observer from at least one direction and sections of respective series are viewable from at least one respective direction different from a direction from which sections of another series are viewable;
graphics on a plurality of sections of each set, the graphics defining a composite image or a plurality of related images that are viewable from the respective direction; and
at least one opening in the matte positioned so as to be viewable by an observer from a first direction together with the image or images defined by a first series of sections and in a second direction together with the image or images defined by a second series of sections.

19. A picture display notebook comprising a notebook having at least one cover and a matte secured to the at least one cover, the matte comprising:
at least two series of interleaved sections arranged in a wave-like manner so that sections of each series are viewable by an observer from at least one direction and sections of respective series are viewable from at least one respective direction different from a direction from which sections of another series are viewable;
graphics on a plurality of sections of each set, the graphics defining a composite image or a plurality of related images that are viewable from the respective direction;
the display device including at least one picture associated with the matte so as to be viewable by an observer from a first direction together with the image or images defined by a first series of sections and in a second direction together with the image or images defined by a second series of sections.
